(19) United States
(12) Patent Application Publication
(10) Pub. No.: US 2026/0004581 A1
(43) Pub. Date: Jan. 1, 2026

(54) METHODS AND APPARATUS FOR DEEPFAKE DETECTION WITH MULTI-SCALE FEATURE PROCESSING AND LOCAL VISUAL DESCRIPTORS

(71) Applicant: Intel Corporation, Santa Clara, CA (US)

(72) Inventors: Anthony Rhodes, Portland, OR (US); Allan Mora Brenes, El Guarco (CR); Sangita Ravi Sharma, Portland, OR (US); Lama Nachman, San Francisco, CA (US)

(73) Assignee: Intel Corporation, Santa Clara, CA (US)

(21) Appl. No.: 19/322,246

(22) Filed: Sep. 8, 2025

(51) Int. Cl. G06V 20/40; G06V 10/25; G06V 10/44; G06V 10/56; G06V 10/764; G06V 10/82; G06V 20/00

(52) U.S. Cl. CPC G06V 20/41; G06V 10/25; G06V 10/44; G06V 10/56; G06V 10/764; G06V 20/95; G06V 10/82

(57) ABSTRACT

Deepfake detection is performed using Multi-Scale Local Descriptor (MSLD) augmentation. The MSLD-based augmentation improves the robustness and generalizability of PPG-based deepfake detection pipelines across a variety of real-world deepfake datasets. Multiscale local descriptor PPG-based features encode blood volume changes across multiple spatial scales in parallel using local binary patterns. A full set of multi-scale PPG maps derived from raw region-of-interest (ROI) images associated with an input video is concatenated with multi-scale local descriptor PPG maps into a single input tensor. The resulting output from the single input tensor is passed to a deepfake detection classifier for classification of the input video as an authentic video or a deepfake.

### BACKGROUND

Deepfake detection seeks to identify photorealistic video and/or image content created with the use of deep learning. Artificial neural network technologies detect content manipulations based on an assessment of visual artifacts, temporal patterns, and/or spatial features. Such manipulation may be indicative of fraud or other corrupt behavior.

### BRIEF DESCRIPTION OF THE DRAWINGS

FIG. 1 illustrates an example Multi-Scale Local Descriptor (MSLD) workflow as performed by deepfake detector circuitry in accordance with methods and apparatus disclosed herein.

FIG. 2 is a table reflecting example binary deepfake classification performance data associated with the MSLD workflow as performed by the deepfake detector circuitry of FIG. 1, including testing on a deepfake detection dataset (e.g., FAVC).

FIG. 3 is a table reflecting example binary deepfake classification performance data associated with the MSLD workflow as performed by the deepfake detector circuitry of FIG. 1, including testing on a forensics-based dataset (e.g., FaceForensics++).

FIG. 4 is a block diagram of an example implementation of the deepfake detector circuitry of FIG. 1 constructed in accordance with teachings of this disclosure to perform deepfake detection with multi-scale feature processing and local visual descriptors.

FIG. 5 is a flowchart representative of example machine-readable instructions and/or example operations that may be executed, instantiated, and/or performed by example programmable circuitry to implement the example deepfake detector circuitry of FIG. 1.

FIG. 6 is a flowchart representative of example machine-readable instructions and/or example operations that may be executed, instantiated, and/or performed by the example deepfake detector circuitry of FIG. 1 to generate multi-scale chrominance-based photo-plethysmography (C-PPG) maps on Region of Interest (ROI) image(s).

FIG. 7 is a flowchart representative of example machine-readable instructions and/or example operations that may be executed, instantiated, and/or performed by the example deepfake detector circuitry of FIG. 1 to generate local descriptor PPG maps based on local binary pattern (LBP) features associated with the ROI image(s).

FIG. 8 is a block diagram of an example processing platform including programmable circuitry structured to execute, instantiate, and/or perform the example machine readable instructions and/or perform the example operations of FIGS. 5-7 to implement the example deepfake detector circuitry of FIG. 1.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 5-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Deepfake technology manipulates images and/or videos using deep learning models to generate deepfake content. Authentic content is difficult to distinguish from such deepfake content that has been altered to appear realistic. Such alterations may spread misinformation through the introduction of synthetic content into the authentic media. Audio and visual content created using deep learning technology includes the use of voice replication, text-to-speech conversion, language conversion, and voice transformation. While deepfake detection can achieve near-perfect accuracy in controlled settings, such detection in real-world settings remains a challenge. Diverse and evolving content-altering methods require the application of advanced detection techniques, given that such deepfake methods can convincingly alter facial features, speech, and/or expressions. Deepfake detection methods include feature-based methods and deep learning-based methods. While feature-based methods use manipulation algorithms to identify artificially constructed features, model-based methods rely on learning patterns obtained from large datasets including original and altered content (e.g., as part of differentiating between authentic and fabricated content).

State-of-the-art solutions leverage deep learning to tune deepfake classifiers to the detection of small (e.g., minute) visual artifacts indicating synthetic provenance. However, artifact-driven deepfake detection methods frequently display overfitting to idiosyncratic, model-dependent generative artifacts, impairing their generalizability and ability to adapt to emerging deepfake generators. Alternative approaches include deepfake detection methods focusing on inconsistencies in the biological domain (e.g., facial attributes, mouth movement, blink rate, etc.). While synthetic content generated by generative adversarial networks (GANs) may appear realistic, such content ignores multidimensional biological signals associated with authentic content. FakeCatcher represents a well-known semantic deepfake detection algorithm that analyzes biological photo-plethysmography (PPG) signals used for measuring blood volume changes in the skin over time. As such, PPG features provide a reliable authenticity signal that can be used to help differentiate real visual content from synthetic visual content. While existing deepfake detection methods provide useful tools for addressing the generation of synthetic content, continuous evolvement of deepfake detection is needed to identify data manipulations as part of targeting deepfake-based misinformation, identify theft, and infringement of privacy.

Methods and apparatus disclosed herein introduce deepfake detection with multiscale feature processing and local visual descriptors. In examples disclosed herein, Multi-Scale Local Descriptor (MSLD) augmentation for PPG-based deepfake detection builds upon proven multi-scale PPG processing a PPG-based local feature descriptor(s). In examples disclosed herein, MSLD augmentation improves the robustness and generalizability of biological signal-based deepfake detection pipelines across a variety of real-world deepfake datasets. In examples disclosed herein, MSLD augmentation generates two sets of PPG-based deepfake detection signals, including a baseline chrominance-based PPG (C-PPG) and a local descriptor variant of the C-PPG features. For robustness, each of these signals is rendered at multiple spatial scales, with the generated features fed into a convolutional neural network (CNN)-based classifier as part of deepfake detection assessment. Deepfake detection methods and apparatus disclosed herein are suitable for a variety of applications, including as part of artificial intelligence (AI) personal computer (PC)-based toolkits, consumer-facing deepfake detection Software as a Service (SaaS), and in proprietary hardware-optimization applications.

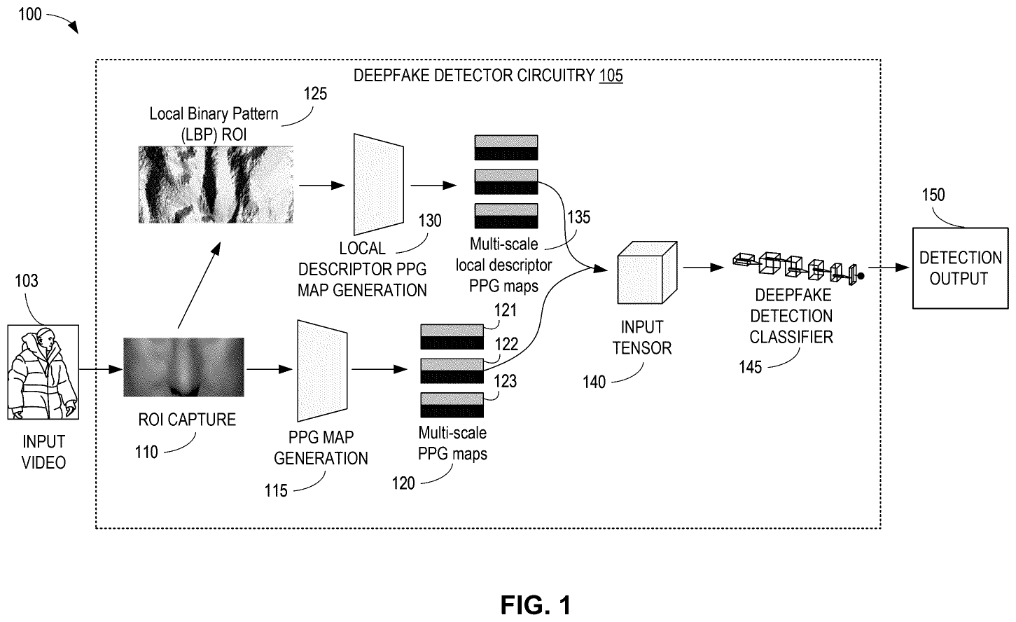

FIG. 1 illustrates an example Multi-Scale Local Descriptor (MSLD) workflow 100 as performed by deepfake detector circuitry 105 in accordance with teachings disclosed herein. In the example of FIG. 1, the deepfake detector circuitry 105 receives an input video 103 for deepfake detection analysis. The deepfake detector circuitry 105 performs analysis based on multi-scale PPG processing and PPG-based local feature descriptors. For example, the input video 103 represents an input video datum with f frames (V_{f}) for deepfake detection. Given the input video 103 (e.g., including distinct facial components), the deepfake detector circuitry 105 of this example initially performs face detection, keypoint extraction, and ROI generation. In the example of FIG. 1, the deepfake detector circuitry 105 extracts a tightly cropped bounding box around identified face(s) in the video using a face detection model (e.g., RetinaFace, Multi-task Cascaded Convolutional Network (MTCNN), etc.). Subsequently, the deepfake detector circuitry 105 extracts and retains facial keypoints corresponding to specific facial regions (e.g., a left cheek, a right cheek, and a nose). The deepfake detector circuitry 105 normalizes a region-of-interest (ROI) associated with an image of the input video 103 by applying several visual transformations (e.g., image warping using Delaunay triangulation) to obtain a final ROI image (e.g., ROI capture 110). For example, image warping using Delaunay triangulation includes the use of a mesh of triangles to deform an image as part of image morphing to correct for distortions and transform the image to a standard or desired spatial configuration. As such, given an image/associated with the input video 103, the deepfake detector circuitry 105 crops the image to obtain a cropped face region, extracts relevant keypoints, and generates an ROI associated with the captured image (e.g., ROI capture 110).

Proceeding to multi-scale PPG map generation (e.g., PPG map generation 115 based on chrominance features) based on the ROI capture 110, the deepfake detector circuitry 105 partitions the ROI image (I_{ROI}) according to three spatial scales (e.g., for coarse-grain processing, intermediate-scale processing, and fine-grain processing). However, any other number of spatial scales and/or corresponding uniform-size cells can be used. For example, the ROI image can be divided into 16 uniform-size cells

$$( {I}_{ROI}^{16} )$$

for coarse-grain processing, 32 uniform-size cells

$$( {I}_{ROI}^{32} )$$

for intermediate-scale processing, and 64 uniform-size cells

$$( {I}_{ROI}^{64} )$$

for fine-grain processing (e.g., as represented by generated multiscale PPG maps 120 associated with variable cell scales 121, 122, 123).

In this example, the deepfake detector circuitry 105 generates chrominance-based photo-plethysmography (C-PPG) features for each of the three ROI spatial scales. Extraction of physiological information using C-PPG can include the extraction of heart rate information from video recordings of an individual's face by leveraging skin-based color changes (e.g., associated with changes in blood volume) to estimate the heart rate (e.g., by applying Fast Fourier Transforms to isolate heart rate frequency from the chrominance signal). In some examples, PPG features can be approximated from RGB features with respect to orthogonal chrominance signals (e.g., denoted X and Y), such that X=3R−2G, Y=1.5R+G−1.5B. The PPG signal is further defined as the normalized difference between X and Y, represented as PPG=X_{f}−αY_{f}, where

$$α = \frac{σ ( {X}_{f} )}{σ ( {Y}_{f} )}$$

is a ratio of the chrominance signal standard deviations and X_{f} and Y_{f} represent band-passed and filtered versions of X and Y, respectively. The deepfake detector circuitry 105 of some examples performs these calculations for each video frame in the input video 103 and across each of the three spatial scales (i.e., using 16, 32 and 64 cells) prior to averaging the PPG values over each cell to yield PPG feature sets of dimensions corresponding to 16×f, 32×f, and 64×f, respectively, for the input video V_{f}.

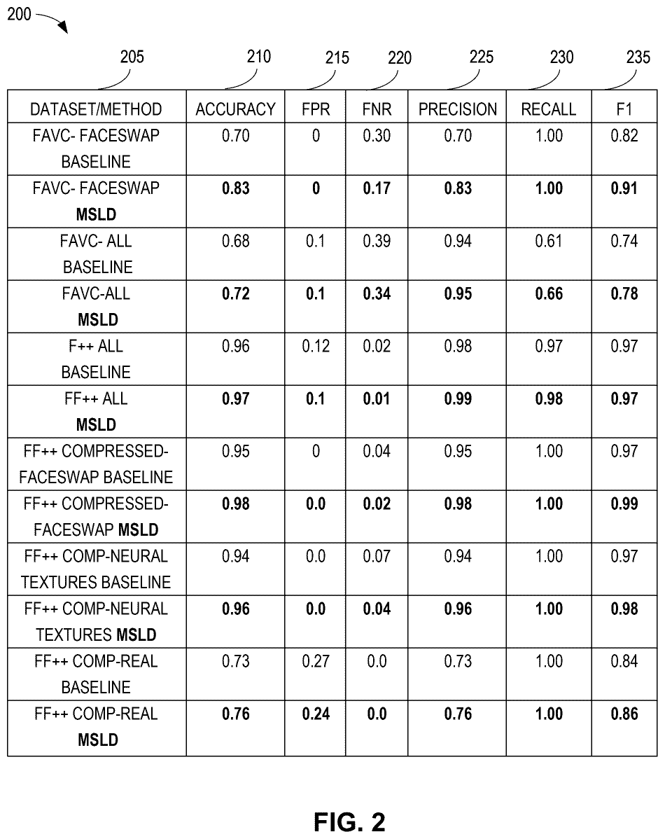

To further improve the representational power of the PPG maps, the deepfake detector circuitry 105 generates spectral PPG maps and concatenates the generated spectral PPG maps with the spatial PPG maps (e.g., generating the multi-scale PPG maps 120). For example, the deepfake detector circuitry 105 renders frequency domain spectral representations of the entire PPG set of features (e.g., 16×f) using Fast Fourier Transforms. The spectral PPG map is subsequently appended to the spatial PPG map (e.g., resizing the spectral PPG map to mirror the size of the spatial PPG map), producing resultant PPG maps of dimensions (16·2)×f, (32·2)×f, and (64·2)×f, respectively. In the example of FIG. 2, the variable cell scales 121, 122, 123 associated with the multi-scale PPG maps 120 include a top (grey) region corresponding to a spatial PPG representation and a bottom (black) region corresponding to a spectral PPG representation.

The deepfake detector circuitry 105 proceeds to produce enhanced PPG maps by leveraging local visual descriptors. For example, the deepfake detector circuitry 105 uses Local Binary Pattern (LBP) features (e.g., LBP ROI 125) to generate local descriptors from the RGB ROI images (e.g., ROI capture 110), treating these descriptors as raw features that are then fed into a PPG generation algorithm (e.g., local descriptor PPG map generation 130 based on local features). LBP is a classical local texture descriptor that is invariant to illumination changes and has demonstrated effectiveness in many computer vision applications, including facial recognition. LBP encodes relative pixel intensities locally, with respect to pixel neighborhoods (e.g., using 3×3 sub-grids). For example, an 8-bit binary string is defined with respect to a central pixel in a 3×3 pixel neighborhood, with the elements of the string encoding reflecting comparative pixel intensities (e.g., whether each neighboring pixel (8 total) has an intensity larger than that of the central pixel). A pixel ordering of the neighbors (e.g., representing a sequence, S_{N}) can be represented as S_{N}=(p₁, p₂, . . . , p_{N-1}) for the N−1 neighbors of pixel p*, such that the LBP encoding for p* is defined in accordance with Equation 1, where I(·) denotes the indicator function and PI(·) symbolizes raw pixel intensity:

$$L B P ( {p}^{*} ) = {\sum }_{i = 1}^{N - 1} {2}^{i - 1} \cdot I [ PI ( {p}_{i} ) > PI ( {p}^{*} ) ] \qquad Equation 1$$

In the example of FIG. 1, the output of the local descriptor PPG map generation (e.g., local descriptor PPG map generation 130) is represented by multi-scale local descriptor PPG maps 135. As described in connection with the multi-scale PPG maps 120, the multi-scale local descriptor PPG maps 135 include a concatenation of the spatial and spectral PPG representations. To perform deepfake detection, the deepfake detector circuitry 105 concatenates the full set of multi-scale PPG maps (e.g., from raw ROI images) with the multi-scale local descriptor PPG maps into a single input tensor (e.g., input tensor 140) and passes the concatenation to the classifier (e.g., deepfake detection classifier 145) to generate a detection output 150 (e.g., identification of whether the input video 103 is an authentic video or a deepfake).

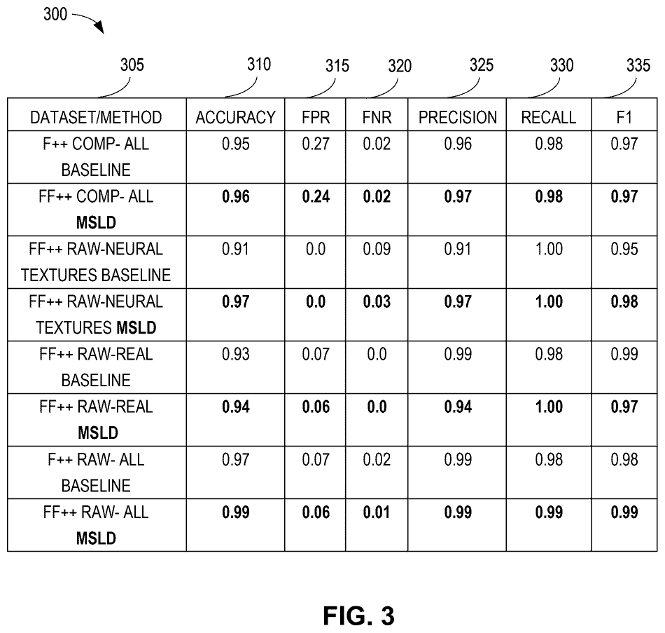

FIG. 2 is a table reflecting example binary deepfake classification performance data 200 associated with the MSLD workflow 100 of FIG. 1 as performed by the deepfake detector circuitry 105 of FIG. 1, including testing on a deepfake detection dataset (e.g., FAVC). Similarly, FIG. 3 is a table reflecting example binary deepfake classification performance data 300 associated with the MSLD workflow 100, including testing on a forensics-based dataset (e.g., FaceForensics++). In the example of FIGS. 2 and 3, deepfake dataset(s) and/or method(s) 205, 305 are compared based on accuracy 210, 310, False Positive Rate (FPR) 215, 315, False Negative Rate (FNR) 220, 320, precision 225, 325, recall 230, 330, and an F1 score 235, 335 (e.g., used for evaluating deepfake detection models based on a balanced measure of both precision and recall). To validate the effectiveness of the MSLD workflow 100 described in connection with FIG. 1, a large set of experiments were initiated using the challenging, real-world problem of binary deepfake classification, comparing performance with a baseline state-of-the-art method (e.g., FakeCatcher (FC) algorithm). In examples disclosed herein, a streamlined 3-layer convolutional neural network (CNN) architecture is selected as a classifier, with Adam optimization and dropout set to 0.2. Both the baseline model and the MSLD are trained for a total of 250 epochs on the publicly available FaceForensics++ dataset, which contains strong class imbalance properties (e.g., a 5:1 synthetic/real proportion), and five unique deepfake generators. In examples disclosed herein, testing can be performed using the FAVC deepfake detection dataset. As shown in connection with FIGS. 2 and 3, MSLD consistently outperforms known deepfake detection methods, including the baseline FakeCatcher algorithm, across a large variety of datasets/subsets and performance metrics.

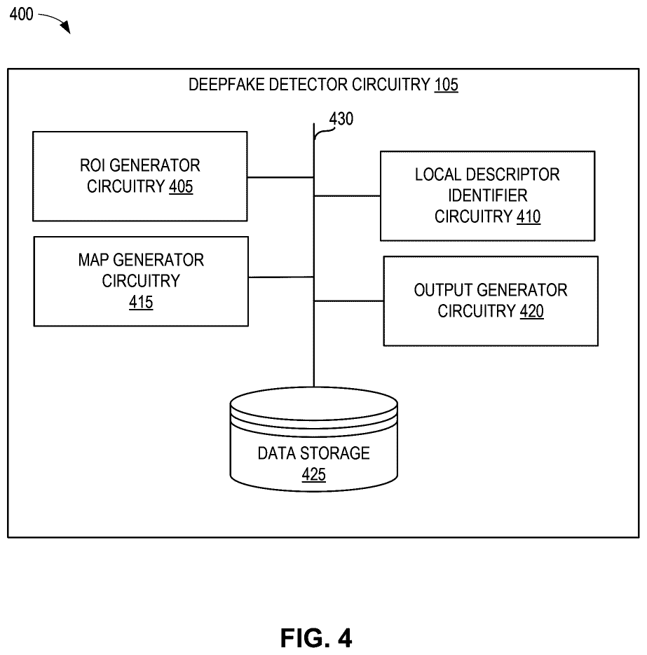

FIG. 4 is a block diagram 400 of an example implementation of the deepfake detector circuitry 105 of FIG. 1 constructed in accordance with teachings of this disclosure to perform deepfake detection with multi-scale feature processing and local visual descriptors. The deepfake detector circuitry 105 of FIG. 1 may be instantiated (e.g., creating an instance of, bring into being for any length of time, materialize, implement, etc.) by programmable circuitry. For example, programmable circuitry may be implemented by a Central Processing Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the deepfake detector circuitry 105 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

In the example of FIG. 4, the deepfake detector circuitry 105 includes example ROI generator circuitry 405, example local descriptor identifier circuitry 410, example map generator circuitry 415, example output generator circuitry 420, and an example data storage 425. In the example of FIG. 4, the ROI generator circuitry 405, the local descriptor identifier circuitry 410, the map generator circuitry 415, the output generator circuitry 420, and the data storage 425 are in communication via an example bus 430.

The ROI generator circuitry 405 generates ROI images (e.g., ROI capture 110 of FIG. 1) based on an input video (e.g., input video 103 of FIG. 1). For example, the ROI generator circuitry 405 applies a face detection model (e.g., RetinaFace) to the input video 103 to extract bounding boxes. The ROI generator circuitry 405 proceeds to extract facial keypoints based on the identified bounding boxes and retains keypoints corresponding to specific facial regions of interest (e.g., mouth, cheeks, etc.). The final region-of-interest (ROI) image(s) are generated using visual transformations such as image warping combined with Delaunay triangulation. However, any other type of visual transformation can be applied to normalize the ROI images prior to PPG map generation.

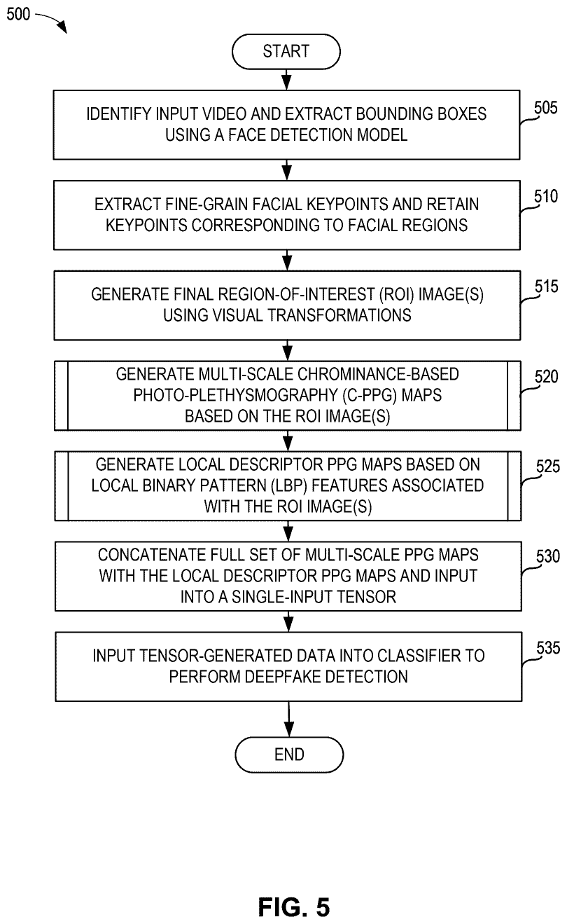

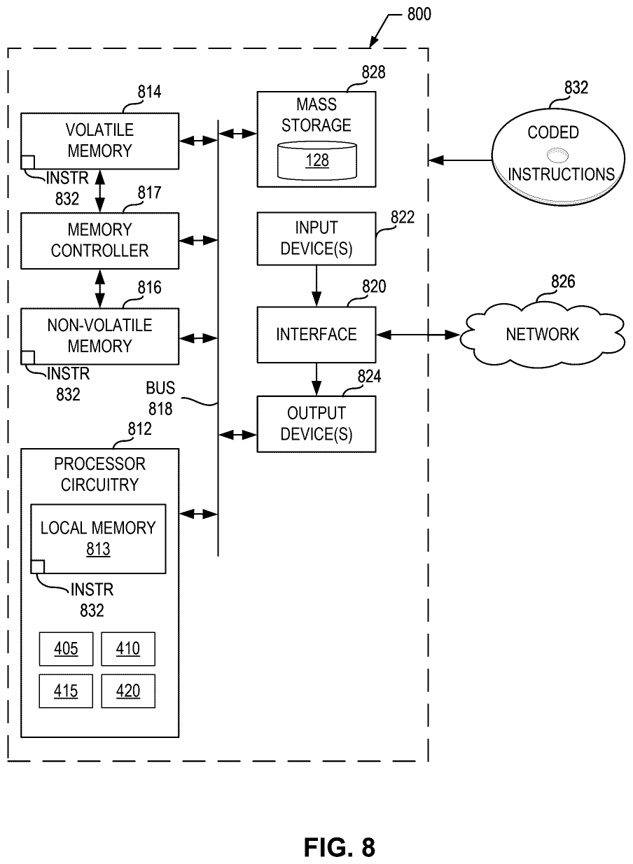

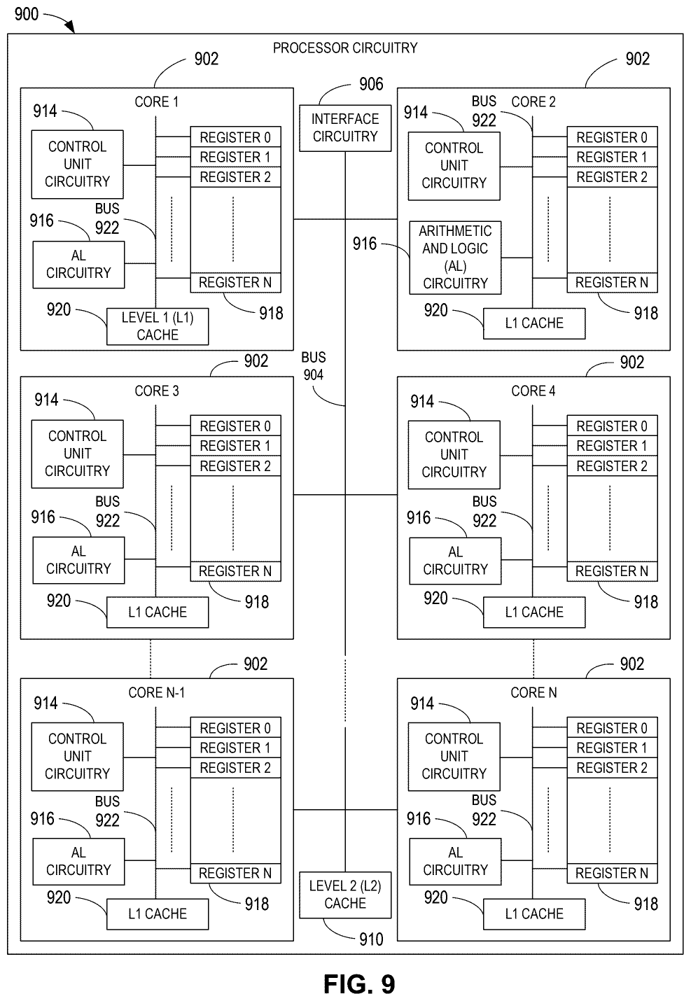

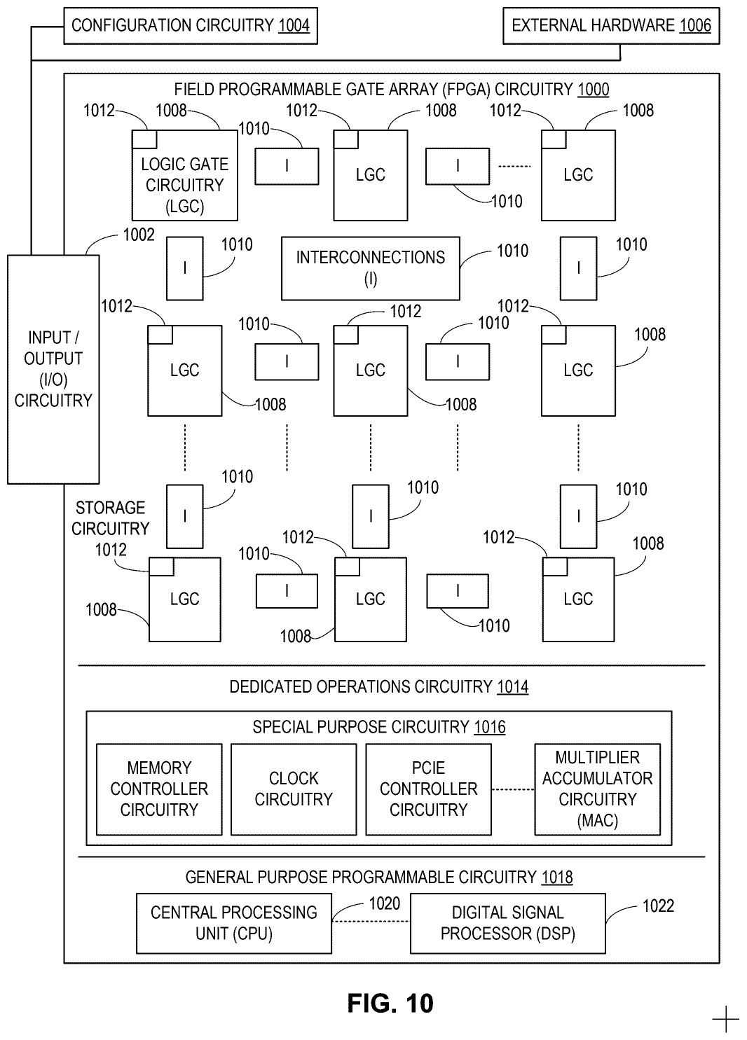

In some examples, the apparatus includes means for identifying a region-of-interest (ROI) image from an input video. For example, the means for identifying an ROI image may be implemented by ROI generator circuitry 405. In some examples, the ROI generator circuitry 405 may be instantiated by programmable circuitry such as the example programmable circuitry 812 of FIG. 8. For instance, the ROI generator circuitry 405 may be instantiated by the example microprocessor 900 of FIG. 9 executing machine executable instructions such as those implemented by at least block(s) 505, 510, 515 of FIG. 5. In some examples, the ROI generator circuitry 405 may be instantiated by hardware logic circuitry, which may be implemented by an ASIC, XPU, or the FPGA circuitry 1000 of FIG. 10 structured to perform operations corresponding to the machine readable instructions. Additionally or alternatively, the ROI generator circuitry 405 may be instantiated by any other combination of hardware, software, and/or firmware. For example, the ROI generator circuitry 405 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The local descriptor identifier circuitry 410 generates local descriptor PPG maps (e.g., multi-scale local descriptor PPG maps 135 of FIG. 1) based on local binary pattern (LBP) features associated with the ROI image(s) (e.g., ROI capture 110). For example, the local descriptor identifier circuitry 410 generates local descriptors from the ROI image(s) based on local binary pattern features and applies the local descriptors as raw feature inputs into select algorithms for multi-scale PPG map generation (e.g., local descriptor PPG map generation 130). For example, the local descriptor identifier circuitry 410 applies LBPs to compare an intensity of a central pixel in a small neighborhood with the intensity of pixels surrounding the central pixel. As such, the local descriptor identifier circuitry 410 assigns each pixel in the neighborhood a binary value based on whether the identified intensity is greater than or less than the intensity of the central pixel, as described in connection with FIG. 1. The binary values are then concatenated into a binary number representing a texture of the neighborhood pixels. In some examples, a histogram representing the frequency of different texture patterns within the ROI can serve as a local descriptor. In some examples, the resulting local descriptors associated with the LBP-based histogram can serve as raw feature inputs to machine learning algorithms such as support vector machines (SVMs), Random Forests, and/or k-Nearest Neighbors (k-NN).

In some examples, the apparatus includes means for generating local features. For example, the means for generating local features may be implemented by local descriptor identifier circuitry 410. In some examples, the local descriptor identifier circuitry 410 may be instantiated by programmable circuitry such as the example programmable circuitry 812 of FIG. 8. For instance, the local descriptor identifier circuitry 410 may be instantiated by the example microprocessor 900 of FIG. 9 executing machine executable instructions such as those implemented by at least block(s) 525 of FIG. 5. In some examples, the local descriptor identifier circuitry 410 may be instantiated by hardware logic circuitry, which may be implemented by an ASIC, XPU, or the FPGA circuitry 1000 of FIG. 10 structured to perform operations corresponding to the machine readable instructions. Additionally or alternatively, the local descriptor identifier circuitry 410 may be instantiated by any other combination of hardware, software, and/or firmware. For example, the local descriptor identifier circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The map generator circuitry 415 generates multi-scale chrominance-based PPG (C-PPG) maps (e.g., multi-scale PPG maps 120 of FIG. 1) based on the ROI image(s) (e.g., ROI capture 110). For example, the map generator circuitry 415 partitions the ROI image according to spatial scales for coarse-grain processing, intermediate-scale processing, and fine-grain processing. As described in connection with FIG. 1, the map generator circuitry 415 partitions the ROI image into 16 uniform-size cells for coarse-grain processing, 32 uniform-size cells for intermediate-scale processing, and 64 uniform-size cells for fine-grain processing. In some examples, the map generator circuitry 415 generates C-PPG features for each video frame and across the spatial scales, such that PPG features can be approximated from RGB features with respect to orthogonal chrominance signals. In some examples, the map generator circuitry 415 approximates the PPG features for each video frame in the input video 103 and across each of the three spatial scales prior to averaging the PPG values over each cell to yield final PPG feature sets. In examples disclosed herein, the map generator circuitry 415 uses C-PPGs to extract physiological signals (e.g., heart rate, blood volume pulse, etc.) from the video data and analyze color information within the video frames, as opposed to solely relying on image intensity changes.

In some examples, the apparatus includes means for generating chrominance features. For example, the means for generating chrominance features may be implemented by map generator circuitry 415. In some examples, the map generator circuitry 415 may be instantiated by programmable circuitry such as the example programmable circuitry 812 of FIG. 8. For instance, the map generator circuitry 415 may be instantiated by the example microprocessor 900 of FIG. 9 executing machine executable instructions such as those implemented by at least block(s) 520 of FIG. 5. In some examples, the map generator circuitry 415 may be instantiated by hardware logic circuitry, which may be implemented by an ASIC, XPU, or the FPGA circuitry 1000 of FIG. 10 structured to perform operations corresponding to the machine readable instructions. Additionally or alternatively, the map generator circuitry 415 may be instantiated by any other combination of hardware, software, and/or firmware. For example, the map generator circuitry 415 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The output generator circuitry 420 generates a deepfake detection output (e.g., detection output 150) based on a concatenation of a full set of multi-scale PPG maps (e.g., multi-scale PPG maps 120) with the local descriptor PPG maps (e.g., multi-scale local descriptor PPG maps 135). For example, the output generator circuitry 420 inputs the concatenation into a single-input tensor (e.g., input tensor 140) and provides the input tensor-generated data to a classifier (e.g., deepfake detection classifier 145). In examples disclosed herein, the deepfake detection classifier 145 is a convolutional neural network (CNN)-based classifier that outputs a prediction indicating whether the input video (e.g., input video 103) is an authentic video or a deepfake. In some examples, the output generator circuitry 420 outputs the prediction as a binary classification or a probability score.

In some examples, the apparatus includes means for performing deepfake detection. For example, the means for performing deepfake detection may be implemented by output generator circuitry 420. In some examples, the output generator circuitry 420 may be instantiated by programmable circuitry such as the example programmable circuitry 812 of FIG. 8. For instance, the output generator circuitry 420 may be instantiated by the example microprocessor 900 of FIG. 9 executing machine executable instructions such as those implemented by at least block(s) 530, 535 of FIG. 5. In some examples, the output generator circuitry 420 may be instantiated by hardware logic circuitry, which may be implemented by an ASIC, XPU, or the FPGA circuitry 1000 of FIG. 10 structured to perform operations corresponding to the machine readable instructions. Additionally or alternatively, the output generator circuitry 420 may be instantiated by any other combination of hardware, software, and/or firmware. For example, the output generator circuitry 420 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data storage 425 can be used to store any information associated with the ROI generator circuitry 405, the local descriptor identifier circuitry 410, the map generator circuitry 415, and/or the output generator circuitry 420. The data storage 425 of the illustrated example of FIG. 4 can be implemented by any memory, storage device and/or storage disc for storing data such as flash memory, magnetic media, optical media, etc. Furthermore, the data stored in the data storage 425 can be in any data format such as binary data, comma delimited data, tab delimited data, structured query language (SQL) structures, image data, etc.

While an example manner of implementing the deepfake detector circuitry 105 is illustrated in FIG. 4, one or more of the elements, processes and/or devices illustrated in FIG. 4 may be combined, divided, re-arranged, omitted, eliminated and/or implemented in any other way. Further, the example ROI generator circuitry 405, the example local descriptor identifier circuitry 410, the example map generator circuitry 415, the example output generator circuitry 420, and/or, more generally, the example deepfake detector circuitry 105 of FIG. 1 may be implemented by hardware, software, firmware and/or any combination of hardware, software and/or firmware. Thus, for example, the ROI generator circuitry 405, the local descriptor identifier circuitry 410, the map generator circuitry 415, the output generator circuitry 420, and/or, more generally, the deepfake detector circuitry 105 of FIG. 1 could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), vision processing units (VPUs), and/or field programmable logic device(s) (FPLD(s)) such as FPGAs in combination with machine readable instructions (e.g., firmware or software). Further still, the deepfake detector circuitry 105 of FIG. 1 may include one or more elements, processes, and/or devices in addition to, or instead of, those illustrated in FIG. 4, and/or may include more than one of any or all of the illustrated elements, processes and devices.

Flowcharts representative of example machine readable instructions, which may be executed by programmable circuitry to implement and/or instantiate the deepfake detector circuitry 105 of FIG. 1 and/or representative of example operations which may be performed by programmable circuitry to implement and/or instantiate the deepfake detector circuitry 105 of FIG. 1, are shown in FIGS. 5-7. The machine readable instructions may be one or more executable programs or portion(s) of one or more executable programs for execution by programmable circuitry, such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 5-7, many other methods of implementing the deepfake detector circuitry 105 of FIG. 1 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

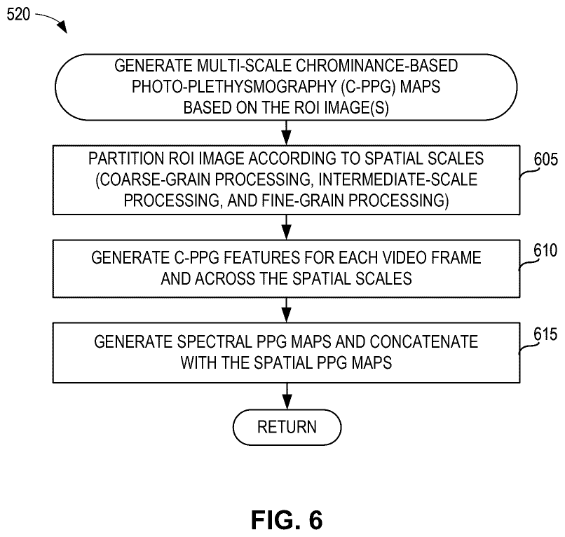

FIG. 5 is a flowchart representative of example machine-readable instructions and/or example operations 500 that may be executed, instantiated, and/or performed by example programmable circuitry to implement the example deepfake detector circuitry 105 of FIG. 1. The machine-readable instructions and/or the operations 500 of FIG. 5 begin at block 505, at which the ROI generator circuitry 405 identifies input video (e.g., an input video of 128 frames) and extracts bounding boxes using a face detection model (e.g., performing face localization using a pre-trained localization model). For example, the ROI generator circuitry 405 receives the input video 103 and decomposes the video into individual frames. Subsequently, the ROI generator circuitry 405 applies a face detection model to each individual frame to determine bounding box coordinates. The ROI generator circuitry 405 proceeds to extract facial keypoints based on the identified bounding boxes and retains keypoints that are specific to facial regions of interest, at block 510. In examples disclosed herein, the facial regions of interest include a right cheek, a left cheek, and a mouth associated with the identified face(s). However, any other facial region(s) can be used for further PPG-based mappings (e.g., facial features allowing for the identification of heart rate). The ROI generator circuitry 405 generates final region-of-interest (ROI) image(s) using visual transformations such as image warping, at block 515. For example, the visual transformations can be performed to normalize the ROI image(s). The map generator circuitry 415 generates multi-scale chrominance-based photo-plethysmography (C-PPG) maps based on the ROI image(s), at block 520 (e.g., where each map is an image of a dimension corresponding to (number of cell(s)×2)×(number of frame(s))). For example, each PPG map includes a column representing a PPG encoding for a particular frame, with a top half of the PPG encoding representing an average pixel value per cell and a bottom half of the PPG map (e.g., number of cell(s)×(number of frame(s))) representing a spectrogram of a top half of the PPG map, resulting in a global representation of the PPG features over the entire 128 frame input. For example, as described in more detail in connection with FIG. 6, the map generator circuitry 415 partitions the ROI image(s) based on a series of spatial scales and generates the C-PPG maps based on a concatenation of spectral maps and spatial maps.

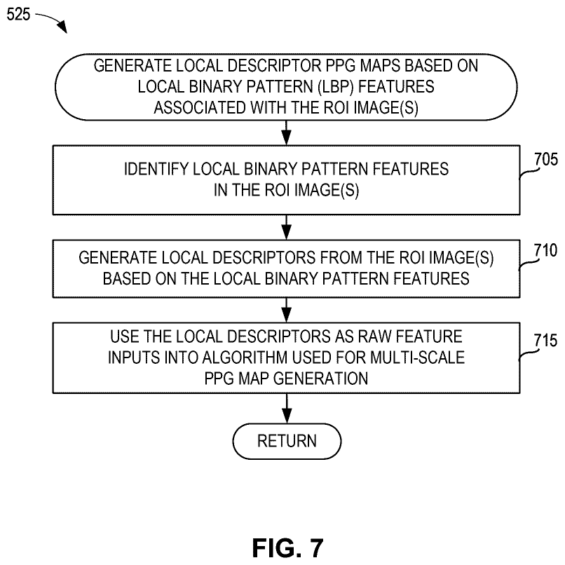

The local descriptor identifier circuitry 410 generates local descriptor PPG maps based on local binary pattern (LBP) features associated with the ROI image(s), at block 525. For example, as described in more detail in connection with FIG. 7, the local descriptor identifier circuitry 410 uses local descriptors as raw feature inputs for generation of multi-scale PPG maps. The output generator circuitry 420 concatenates the full set of multi-scale PPG maps (e.g., generated using the map generator circuitry 415) with the local descriptor PPG maps (e.g., generated using the local descriptor identifier circuitry 410) and inputs the concatenation into a single-input tensor, at block 530 (e.g., concatenating the set of PPG and LBP-PPG maps, row-wise, to create a single two-dimensional image). The output generator circuitry 420 routes the tensor-generated data into a classifier (e.g., CNN-based classifier) to perform deepfake detection. For example, the output generator circuitry 420 generates an output representative of deepfake detection results associated with the input video 103 of FIG. 1 (e.g., classifying the input video 103 as a deepfake or an authentic video). For example, the two-dimensional image, which includes both the PPG and LBP-PPG maps across three different scales, is processed by the CNN to determine whether the image is a deepfake.

FIG. 6 is a flowchart representative of example machine-readable instructions and/or example operations 520 that may be executed, instantiated, and/or performed by the example deepfake detector circuitry 105 of FIG. 1 to generate multi-scale chrominance-based photo-plethysmography (C-PPG) maps on Region of Interest (ROI) image(s). The machine-readable instructions and/or the operations 520 of FIG. 5 begin at block 605, at which the map generator circuitry 415 partitions the ROI image according to several spatial scales to perform coarse-grain processing, intermediate-scale processing, and fine-grain processing. For example, the map generator circuitry 415 partitions the ROI image into 16 uniform-size cells, 32 uniform-size cells, and 64 uniform-size cells for coarse-grain processing, intermediate-scale processing, and fine-grain processing, respectively. The map generator circuitry 415 generates C-PPG features for each video frame and across the spatial scales, at block 610. For example, the map generator circuitry 415 analyzes biological PPG signals used for measuring blood volume changes in the skin over time. As such, the generated C-PPG features provide a reliable authenticity signal that can be used to help differentiate real visual content from synthetic visual content as part of deepfake detection. The map generator circuitry 415 proceeds to generate spectral PPG maps and concatenate the spatial PPG maps with the spectral PPG maps to yield multi-scale PPG maps, at block 615.

FIG. 7 is a flowchart representative of example machine-readable instructions and/or example operations 525 that may be executed, instantiated, and/or performed by the example deepfake detector circuitry 105 of FIG. 1 to generate local descriptor PPG maps based on local binary pattern (LBP) features associated with the ROI image(s). The machine-readable instructions and/or the operations 525 of FIG. 5 begin at block 705, at which the local descriptor identifier circuitry 410 identifies local binary pattern features in the ROI image(s). For example, the local binary pattern features correspond to local texture features of an image. The local descriptor identifier circuitry 410 generates local descriptors from the ROI image(s) based on the local binary pattern features, at block 710. For example, histograms of the local features can be used to obtain the local descriptors. The local descriptor identifier circuitry 410 uses the local descriptors as raw feature inputs into algorithms for PPG map generation, at block 715.

FIG. 8 is a block diagram of an example processing platform 800 including programmable circuitry structured to execute, instantiate, and/or perform the example machine readable instructions and/or perform the example operations of FIGS. 5-7 to implement the example deepfake detector circuitry 105 of FIG. 1. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs microprocessors, CPUs, GPUs, DSPs, and/or microcontrollers from any desired family or manufacturer. The programmable circuitry 812 may be implemented by one or more semiconductor based (e.g., silicon based) devices. In this example, the processor circuitry 812 implements the ROI generator circuitry 405, the local descriptor identifier circuitry 410, the map generator circuitry 415, and the output generator circuitry 420.

The programmable circuitry 812 of the illustrated example includes a local memory 813 (e.g., a cache, registers, etc.). The programmable circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 800 of the illustrated example also includes one or more mass storage devices 828 to store software and/or data. Examples of such mass storage devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 832, which may be implemented by the machine readable instructions of FIGS. 5-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general purpose microprocessor (e.g., general purpose microprocessor circuitry). The microprocessor 900 executes some or all of the machine readable instructions of the flowcharts of FIGS. 5-7 to effectively instantiate the circuitry of FIG. 4 logic circuits to perform the operations corresponding to those machine readable instructions. In some such examples, the circuitry of FIG. 4 is instantiated by the hardware circuits of the microprocessor 900 in combination with the instructions. For example, the microprocessor 900 may implement multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 5-7.

The cores 902 may communicate by a first example bus 904. In some examples, the first bus 904 may implement a communication bus to effectuate communication associated with one(s) of the cores 902. For example, the first bus 904 may implement at least one of an Inter-Integrated Circuit (I2C) bus, a Serial Peripheral Interface (SPI) bus, a PCI bus, or a PCIe bus. Additionally or alternatively, the first bus 904 may implement any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2_cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the L1 cache 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer-based operations. In other examples, the AL circuitry 916 also performs floating-point operations. In yet other examples, the AL circuitry 916 may include first AL circuitry that performs integer-based operations and second AL circuitry that performs floating point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 1000 of FIG. 10 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowcharts of FIGS. 5-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 5-7. In particular, the FPGA 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 5-7. As such, the FPGA circuitry 1000 may be configured and/or structured to effectively instantiate some or all of the operations/functions corresponding to the machine readable instructions of the flowcharts of FIGS. 5-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 5-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 5-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 10. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 1002 of FIG. 10 may execute a first portion of the machine readable instructions represented by the flowchart(s) of FIGS. 5-7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIGS. 5-7, and/or an ASIC may be configured and/or structured to perform third operation(s)/function(s) corresponding to a third portion of the machine readable instructions represented by the flowcharts of FIGS. 5-7.

It should be understood that some or all of the circuitry of FIG. 4 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 4 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8 which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

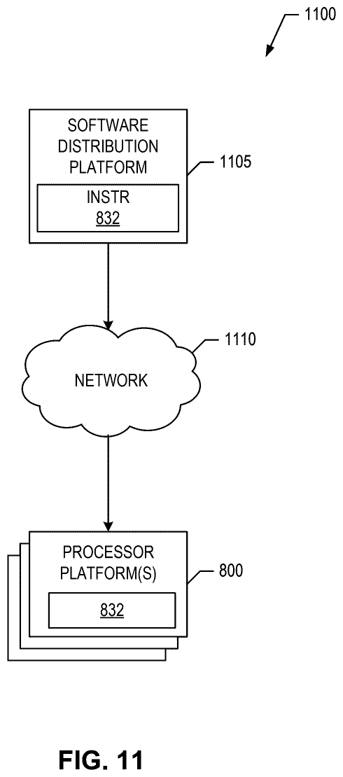

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 832, which may correspond to the example machine readable instructions of FIGS. 5-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 5-7, may be downloaded to the example programmable circuitry platform 800, which is to execute the machine readable instructions 832 to implement the deepfake detector circuitry 105 of FIG. 1. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein apply biological photo-plethysmography (PPG) signals for deepfake detection. Example methods and apparatus disclosed herein improve the robustness and generalizability of biological signal-based deepfake detection pipelines across a variety of real-world deepfake datasets. In examples disclosed herein, a baseline chrominance-based PPG (C-PPG) and a local descriptor variant of the C-PPG features can be rendered at multiple spatial scales and fed into a convolutional neural network (CNN)-based classifier as part of deepfake detection assessment. Deepfake detection methods disclosed herein can be implemented in artificial intelligence (AI) personal computer (PC)-based toolkits, consumer-facing deepfake detection Software as a Service (SaaS), and/or hardware optimization-based applications. Thus, examples disclosed herein result in improvements to the operation of a machine.

Example methods, apparatus, systems, and articles of manufacture for deepfake detection with multi-scale feature processing and local visual descriptors are disclosed herein. Further examples and combinations thereof include the following:

Example 1 includes an apparatus, comprising interface circuitry, machine-readable instructions, and at least one processor circuit to be programmed by the machine-readable instructions to identify a region-of-interest (ROI) from an input video, generate chrominance features based on the ROI, generate local features based on the ROI, combine the chrominance features and the local features into an input tensor, and classify, using a machine learning model, the video as authentic or a deepfake based on the input tensor.

Example 2 includes the apparatus as defined in example 1, wherein one or more of the at least one processor circuit is to generate the chrominance features by partitioning the ROI into spatial scales.

Example 3 includes the apparatus as defined in one or more of examples 1-2, wherein the spatial scales include 16, 32, or 64 uniform-size cells.

Example 4 includes the apparatus as defined in one or more of examples 1-3, wherein the spatial scales respectively correspond to coarse-grain processing, intermediate-scale processing, or fine-grain processing.

Example 5 includes the apparatus as defined in one or more of examples 1-4, wherein one or more of the at least one processor circuit is to generate the local features based on local binary pattern (LBP) features of the ROI.

Example 6 includes the apparatus as defined in one or more of examples 1-5, wherein one or more of the at least one processor circuit is to determine the LBP features based on an indicator function and raw pixel intensity of the ROI.

Example 7 includes the apparatus as defined in one or more of examples 1-6, wherein one or more of the at least one processor circuit is to generate a multi-scale photo-plethysmography (PPG) map based on a concatenation of a spectral PPG map associated with spectral features of the ROI and a spatial PPG map associated with spatial features of the ROI.

Example 8 includes at least one non-transitory machine-readable medium comprising machine-readable instructions to cause at least one processor circuit to at least generate chrominance features based on a region-of-interest (ROI) from an input video, generate local features based on the ROI, concatenate the chrominance features and the local features, and perform deepfake detection with a single-input tensor based on the concatenation of the chrominance features and the local features.

Example 9 includes the at least one non-transitory machine-readable medium as defined in example 8, wherein the machine-readable instructions are to cause one or more of the at least one processor circuit to generate the chrominance features by partitioning the ROI into spatial scales.

Example 10 includes the at least one non-transitory machine-readable medium as defined in one or more of examples 8-9, wherein the spatial scales include 16, 32, or 64 uniform-size cells.

Example 11 includes the at least one non-transitory machine-readable medium as defined in one or more of examples 8-10, wherein the spatial scales respectively correspond to coarse-grain processing, intermediate-scale processing, or fine-grain processing.

Example 12 includes the at least one non-transitory machine-readable medium as defined in one or more of examples 8-11, wherein the machine-readable instructions are to cause one or more of the at least one processor circuit to generate the local features based on local binary pattern (LBP) features of the ROI.

Example 13 includes the at least one non-transitory machine-readable medium as defined in one or more of examples 8-12, wherein the machine-readable instructions are to cause one or more of the at least one processor circuit to determine the LBP features based on an indicator function and raw pixel intensity of the ROI.

Example 14 includes the at least one non-transitory machine-readable medium as defined in one or more of examples 8-13, wherein the machine-readable instructions are to cause one or more of the at least one processor circuit to generate a multi-scale photo-plethysmography (PPG) map based on a concatenation of a spectral PPG map associated with spectral features of the ROI and a spatial PPG map associated with spatial features of the ROI.

Example 15 includes an apparatus, comprising means for identifying a region-of-interest (ROI) from an input video, means for generating to generate chrominance features based on the ROI, generate local features based on the ROI, and combine the chrominance features and the local features into an input tensor, and means for performing deepfake detection to classify the video as authentic or a deepfake based on the input tensor.

Example 16 includes the apparatus as defined in example 15, wherein the means for identifying is to generate the chrominance features by partitioning the ROI into spatial scales.

Example 17 includes the apparatus as defined in one or more of examples 15-16, wherein the spatial scales include 16, 32, or 64 uniform-size cells.

Example 18 includes the apparatus as defined in one or more of examples 15-17, wherein the spatial scales respectively correspond to coarse-grain processing, intermediate-scale processing, or fine-grain processing.

Example 19 includes the apparatus as defined in one or more of examples 15-18, wherein the means for generating is to generate the local features based on local binary pattern (LBP) features of the ROI.

Example 20 includes the apparatus as defined in one or more of examples 15-19, wherein the means for generating is to determine the LBP features based on an indicator function and raw pixel intensity of the ROI.

Example 21 includes the apparatus as defined in one or more of examples 15-20, wherein the means for generating is to generate a multi-scale photo-plethysmography (PPG) map based on a concatenation of a spectral PPG map associated with spectral features of the ROI and a spatial PPG map associated with spatial features of the ROI.

Example 22 includes a method, comprising identifying a region-of-interest (ROI) from an input video, generating chrominance features based on the ROI, generating local features based on the ROI, combine the chrominance features and the local features into an input tensor, and classify the video as authentic or a deepfake based on the single-input tensor.

Example 23 includes the method as defined in example 22, further including generating the chrominance features by partitioning the ROI into spatial scales.

Example 24 includes the method as defined in one or more of examples 22-23, wherein the spatial scales include 16, 32, or 64 uniform-size cells.

Example 25 includes the method as defined in one or more of examples 22-24, wherein the spatial scales respectively correspond to coarse-grain processing, intermediate-scale processing, or fine-grain processing.

Example 26 includes the method as defined in one or more of examples 22-25, further including generating the local features based on local binary pattern (LBP) features of the ROI.

Example 27 includes the method as defined in one or more of examples 22-26, further including determining the LBP features based on an indicator function and raw pixel intensity of the ROI.

Example 28 includes the method as defined in one or more of examples 22-27, further including generating a multi-scale photo-plethysmography (PPG) map based on a concatenation of a spectral PPG map associated with spectral features of the ROI and a spatial PPG map associated with spatial features of the ROI.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit to be programmed by the machine-readable instructions to:
identify a region-of-interest (ROI) from an input video;
generate chrominance features based on the ROI;
generate local features based on the ROI;
combine the chrominance features and the local features into an input tensor; and
classify, using a machine learning model, the video as authentic or a deepfake based on the input tensor.

2. The apparatus of claim 1, wherein one or more of the at least one processor circuit is to generate the chrominance features by partitioning the ROI into spatial scales.

3. The apparatus of claim 2, wherein the spatial scales include 16, 32, or 64 uniform-size cells.

4. The apparatus of claim 2, wherein the spatial scales respectively correspond to coarse-grain processing, intermediate-scale processing, or fine-grain processing.

5. The apparatus of claim 1, wherein one or more of the at least one processor circuit is to generate the local features based on local binary pattern (LBP) features of the ROI.

6. The apparatus of claim 5, wherein one or more of the at least one processor circuit is to determine the LBP features based on an indicator function and raw pixel intensity of the ROI.

7. The apparatus of claim 1, wherein one or more of the at least one processor circuit is to generate a multi-scale photo-plethysmography (PPG) map based on a concatenation of a spectral PPG map associated with spectral features of the ROI and a spatial PPG map associated with spatial features of the ROI.

8. At least one non-transitory machine-readable medium comprising machine-readable instructions to cause at least one processor circuit to at least:
generate chrominance features based on a region-of-interest (ROI) from an input video;
generate local features based on the ROI;
concatenate the chrominance features and the local features; and
perform deepfake detection with a single-input tensor based on the concatenation of the chrominance features and the local features.

9. The at least one non-transitory machine-readable medium of claim 8, wherein the machine-readable instructions are to cause one or more of the at least one processor circuit to generate the chrominance features by partitioning the ROI into spatial scales.

10. The at least one non-transitory machine-readable medium of claim 9, wherein the spatial scales include 16, 32, or 64 uniform-size cells.

11. The at least one non-transitory machine-readable medium of claim 9, wherein the spatial scales respectively correspond to coarse-grain processing, intermediate-scale processing, or fine-grain processing.

12. The at least one non-transitory machine-readable medium of claim 8, wherein the machine-readable instructions are to cause one or more of the at least one processor circuit to generate the local features based on local binary pattern (LBP) features of the ROI.

13. The at least one non-transitory machine-readable medium of claim 12, wherein the machine-readable instructions are to cause one or more of the at least one processor circuit to determine the LBP features based on an indicator function and raw pixel intensity of the ROI.

14. The at least one non-transitory machine-readable medium of claim 10, wherein the machine-readable instructions are to cause one or more of the at least one processor circuit to generate a multi-scale photo-plethysmography (PPG) map based on a concatenation of a spectral PPG map associated with spectral features of the ROI and a spatial PPG map associated with spatial features of the ROI.

15. An apparatus, comprising:
means for identifying a region-of-interest (ROI) from an input video;
means for generating to:
generate chrominance features based on the ROI;
generate local features based on the ROI; and
combine the chrominance features and the local features into an input tensor; and
means for performing deepfake detection to classify, using a machine learning model, the video as authentic or a deepfake based on the input tensor.

16. The apparatus of claim 15, wherein the means for identifying is to generate the chrominance features by partitioning the ROI into spatial scales.

17. The apparatus of claim 16, wherein the spatial scales include 16, 32, or 64 uniform-size cells.

18. The apparatus of claim 16, wherein the spatial scales respectively correspond to coarse-grain processing, intermediate-scale processing, or fine-grain processing.

19. The apparatus of claim 15, wherein the means for generating is to generate the local features based on local binary pattern (LBP) features of the ROI.

20. The apparatus of claim 19, wherein the means for generating is to determine the LBP features based on an indicator function and raw pixel intensity of the ROI.
